(19) United States
(12) Patent Application Publication
(10) Pub. No.: US 2012/0013551 A1
(43) Pub. Date: Jan. 19, 2012

(54) METHOD FOR INTERACTING WITH AN APPLICATION IN A COMPUTING DEVICE COMPRISING A TOUCH SCREEN PANEL

(76) Inventors: Jean-Baptiste MARTINOLI, St-Anaclet-de-Lessard (CA); Jacques Desplat, Lyon (FR)

(21) Appl. No.: 13/007,135

(22) Filed: Jan. 14, 2011

Related U.S. Application Data
(60) Provisional application No. 61/365,003, filed on Jul. 16, 2010.

(51) Int. Cl. G06F 3/041

(52) U.S. Cl. 345/173

(57) ABSTRACT

A method for interacting with an application in a computing device comprising a touch screen panel, the method comprising displaying an icon on the touch screen panel, the icon being representative of the application and executing a given process upon detection of a finger motion, the finger motion starting above the icon and being in a direction facing the outside of the touch screen panel.

### CROSS-REFERENCE TO RELATED APPLICATIONS

This patent application claims priority of US Provisional patent application No. 61/365,003 entitled “Method for interacting with an application in a device comprising a touch screen panel” that was filed on Jul. 16, 2010, the specification of which is hereby incorporated by reference.

### FIELD OF THE INVENTION

The invention relates to the field of computing devices having a touch screen panel. More precisely, this invention pertains to a method for interacting with an application in a computing device comprising a touch screen panel.

### BACKGROUND OF THE INVENTION

There exist today many types of input devices for performing operations in a computer device.

Unfortunately the interactions with the computer device may still be cumbersome in some cases. This is particularly the case for multi-tasking operating systems where many applications can be concurrently executed. In such cases, navigating between applications for terminating one is not easy which is a drawback.

With the release of portable computers with touch screen panels, the issue is even more complex since often one hand is already taken for holding the computer which is a drawback.

There is a need for a method for interacting with an application that will overcome at least one of the above-identified drawbacks.

Features of the invention will be apparent from review of the disclosure, drawings and description of the invention below.

### BRIEF SUMMARY

According to one embodiment, there is provided a method for interacting with an application in a computing device comprising a touch screen panel, the method comprising displaying an icon on the touch screen panel, the icon being representative of the application and executing a given process upon detection of a finger motion, said finger motion starting above the icon and being in a direction facing the outside of the touch screen panel.

In an embodiment, the application is currently running.

In yet another embodiment, the detection of a finger motion comprises detecting a selection of the icon and detecting a translation motion of a finger.

In yet another embodiment, the detection of the icon comprises detecting the touching of the icon by the finger.

In yet another embodiment, the detection of a translation motion of a finger is performed immediately following the touching of the icon by the finger.

In an embodiment, the icon is moved.

In yet another embodiment, the icon is moved concurrently with the translation motion of the finger.

In yet another embodiment, the translation motion of the finger is horizontal.

In an embodiment, the given process causes the application to be terminated when executed.

In yet another embodiment, the given process causes the application to be put in an idle mode when executed.

In accordance with an embodiment, there is provided a computer-readable storage medium storing computer-executable instructions which, when executed, cause a computing device comprising a touch screen panel to perform a method for interacting with an application comprising displaying an icon on the touch screen panel, the icon being representative of the application and executing a given process upon detection of a finger motion, the finger motion starting above the icon and being in a direction facing the outside of the touch screen panel.

In yet another embodiment, the detection of a finger motion comprises detecting a selection of the icon and detecting a translation motion of a finger.

In accordance with another embodiment, there is provided a computing device, comprising a touch screen panel, one or more central processing units, a memory comprising an application and one or more programs, wherein the one or more programs are stored in the memory and configured to be executed by the one or more central processing units, the one or more programs including instructions for displaying an icon on the touch screen panel, the icon being representative of the application and instructions for executing a given process upon detection of a finger motion, said finger motion starting above the icon and being in a direction facing the outside of the touch screen panel.

In yet another embodiment, the application is currently running.

In yet another embodiment, the given process causes the application to be terminated when executed.

In yet another embodiment, the given process causes the application to be put in an idle mode when executed.

In yet another embodiment, the detection of a finger motion comprises detecting a selection of the icon and detecting a translation motion of a finger.

In accordance with one embodiment the given process is one for achieving the shutting down of a given application running.

### BRIEF DESCRIPTION OF THE DRAWINGS

In order that the invention may be readily understood, embodiments of the invention are illustrated by way of example in the accompanying drawings.

FIG. 1 is a block diagram which shows an embodiment of a computing device in which an embodiment of a method for interacting with an application in a device comprising a touch screen panel may be implemented.

FIG. 2 is a flowchart which shows an embodiment of a method for interacting with an application in a computing device comprising a touch screen panel; according to a first processing step an icon is displayed and according to a second step a process is executed upon detection of a finger motion.

FIG. 3 is a flowchart which shows an embodiment of how the process is executed upon detection of a finger motion.

FIG. 4 is a diagram which shows an embodiment of a graphics user interface in which an embodiment of the method for interacting with an application in a computing device comprising a touch screen may be implemented.

FIG. 5 is an enlarged view of one part of the graphics user interface in which an interaction may be performed.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

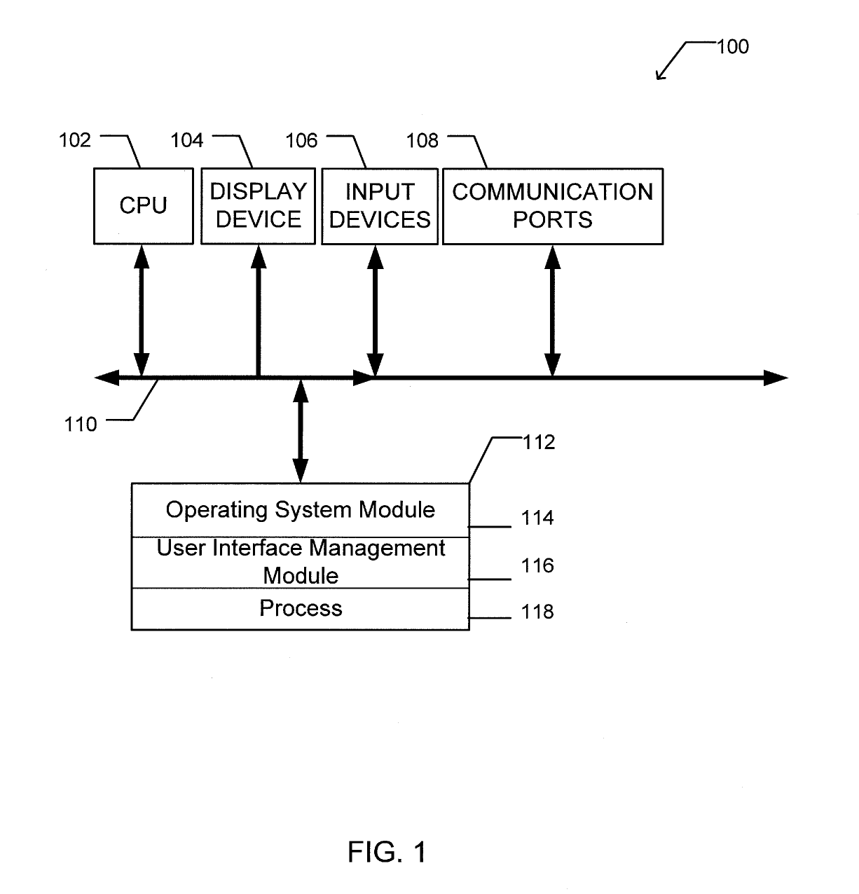

Now referring to FIG. 1, there is shown an embodiment of a computing device 100 in which an embodiment of the method for interacting with an application in a computing device comprising a touch screen panel may be implemented.

In this embodiment the computing device 100 comprises at least one Central Processing Unit (CPU) 102, a display device 104, input devices 106, communication ports 108, a data bus 110 and a memory 112.

The at least one Central Processing Unit 102, the display device 104, the input devices 106, communication ports 108 and the memory 112 are connected together using the data bus 110.

In one embodiment the computing device 100 is the ExoPC™ manufactured by Pegatron. Still in this embodiment the at least one Central Processing Unit 102 comprises an Atom Pineview-M N450 manufactured by Intel™, running at 1.66 GHz and supporting 64 bits.

Still in this embodiment, the display device 104 comprises a touch screen panel having 11.6-inch width and a resolution of 1366×768 pixels with 135 pixels per inch. The touch screen panel uses a multipoint capacitive technology known to the ones skilled in the art. The display device 104 further comprises a GMA500 graphics card manufactured by Intel™.

The input devices 106 are used for providing data to the apparatus 100.

In this embodiment, the input devices 106 comprise an accelerometer, a microphone, a luminosity sensor and a camera. The skilled addressee will appreciate that various other embodiments for the input devices 106 may alternatively be provided.

The communications ports 108 are used for enabling a communication of the apparatus 100 with other devices.

In this embodiment, the communication ports 108 comprise a WIFI 802.11b/g/n port, a Bluetooth 2.1+EDR port, two USB 2.0 ports, a SD/SDHC card reader and a mini HDMI port. The skilled addressee will again appreciate that various other embodiments may be provided for the communication ports 108.

The memory 112 is used to store data.

In this embodiment, the memory 112 comprises a Solid State Drive (SSD) having a capacity of either 32 or 64 GB.

More precisely and still in this embodiment, the memory 112 comprises, inter alia, an operating system module 114. The operating system module 114 is Windows 7™ Home Premium Edition manufactured by Microsoft™.

The memory 112 further comprises a user interface management module 116. The user interface management 116 is used to manage the user interface of the computing device 100.

It will be appreciated that the method for interacting with an application in a computing device comprising a touch screen panel may be implemented for instance within the user interface management module 116, i.e. be a component of it and be constituted of one or more programs, wherein the one or more programs are configured to be executed by the at least one Central Processing Unit (CPU) 102, the one or more programs comprising instructions for displaying an icon on the touch screen panel, the icon being representative of the application and instructions for executing a given process upon detection of a finger motion, the finger motion starting above the icon and being in a direction facing the outside of the touch screen panel.

The memory 112 further comprises a process 118. It will be appreciated that the process 118 may be of various types. For instance the process may be an application running.

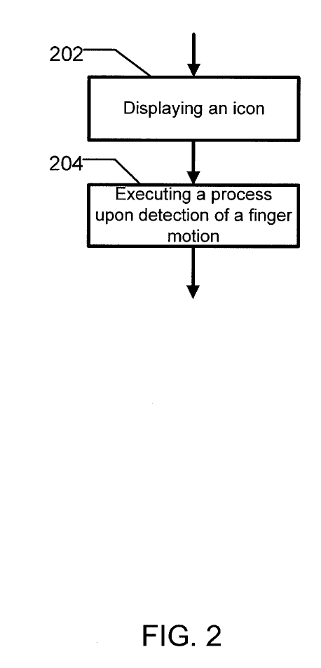

Now referring to FIG. 2, there is shown an embodiment of a method for interacting with an application in a computing device comprising a touch screen panel.

According to processing step 202, an icon is displayed. In one embodiment, the icon is displayed in a graphics user interface.

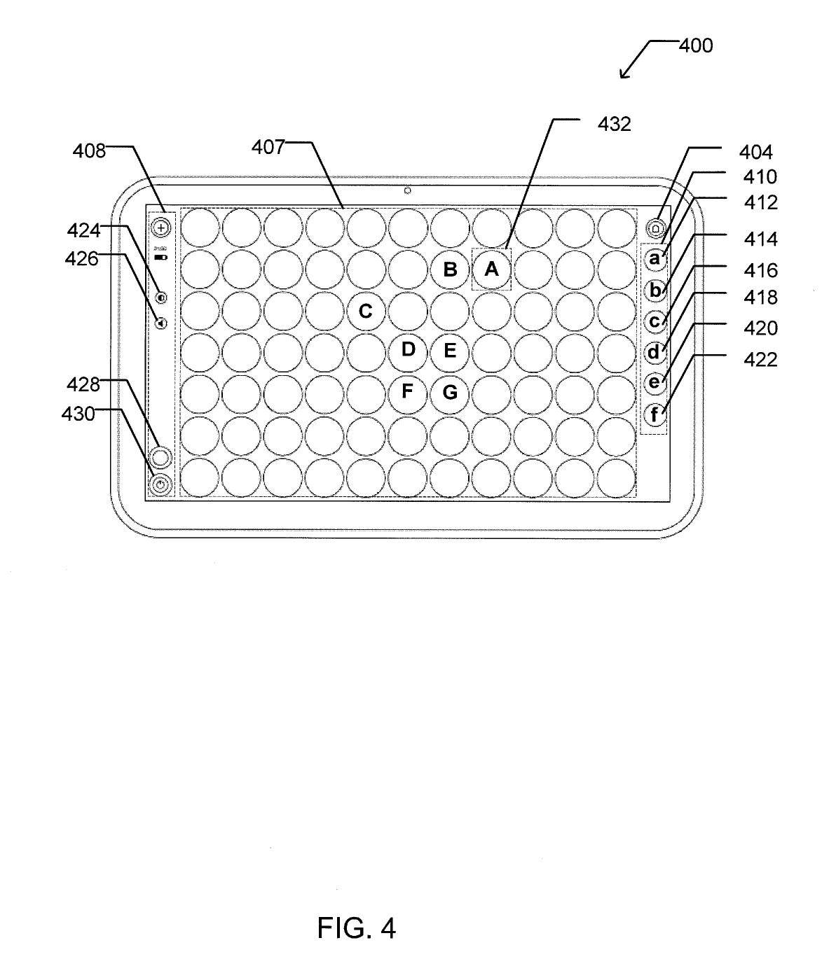

Now referring to FIG. 4, there is shown an embodiment of a graphics user interface 400 of a computing device 100 in which an embodiment of the method for interacting with an application in a computing device comprising a touch screen panel may be implemented.

The graphics user interface 400 comprises a left hand portion 408, a central portion 407 and a right hand portion comprising a home button 404 and a display application portion 410.

The left hand portion 408 comprises a plurality of icons each used for a specific function. For instance and in the embodiment shown in FIG. 4, icon 424 is used for adjusting luminosity and contrast, icon 426 is used for controlling the volume of the sound output, icon 428 is used for starting a menu and icon 430 is used for starting/stopping the apparatus 100.

The central portion 407 is used for displaying a plurality of applications installed in the computing device 100. In the embodiment shown in FIG. 4, applications A, B, C, D, E, F and G are available. For instance and in one embodiment, application A can be launched by touching icon 432.

It will be appreciated that each of the available circles can host an icon representative of an application available for execution. Moreover, it will be appreciated that a background image, not shown, may be provided in background of the plurality of circles. In an alternative embodiment, geometric shapes other than a circle may be used for receiving icons representative of an application.

The right hand portion comprises a home button 404 for accessing a home menu comprising all the icons of available applications.

The display application portion 410 comprises a plurality of icons representative of applications that are currently being executed, i.e. currently running.

For instance, icon 412 is representative of application A that is being currently executed, icon 414 is representative of application B that is being currently executed, icon 416 is representative of application C that is being currently executed, icon 418 is representative of application D that is being currently executed, icon 420 is representative of application E that is being currently executed and icon 422 is representative of application F that is being currently executed.

The skilled addressee will appreciate that it is possible to access a given application being executed by touching the icon representative of the application sought. For instance, a user can access application F by touching icon 422.

A user may therefore easily toggle between applications using the display application portion 410.

Now referring back to FIG. 2 and according to processing step 204, a process is executed upon a detection of a finger motion. It will be appreciated that in a preferred embodiment, the process executed is one for terminating a given application running in the apparatus 100.

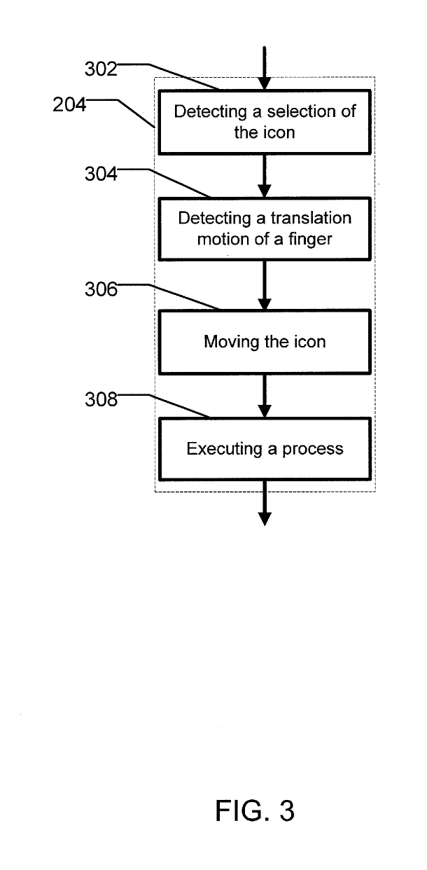

Now referring to FIG. 3, there is shown an embodiment of how processing step 204 is performed.

According to processing step 302, a selection of an icon is detected.

In a preferred embodiment, the icon is selected by touching the icon. The detection is therefore performed by detecting that the icon has been touched. Still in a preferred embodiment, the detection is performed by detecting that the icon has been touched by a finger.

It will be appreciated that the icon to be selected is one of the icon displayed in the display application portion 410.

According to processing step 304, a translation motion of a finger is detected. In a preferred embodiment, the translation motion is detected immediately following the touching of the icon. Still in one embodiment, the translation motion starts above the icon and is in a direction facing the outside of the touch screen panel.

In a preferred embodiment, the translation motion is performed in the direction facing the inside of the hand of the user performing the motion and is horizontal. The skilled addressee will appreciate that in the case of the user interface shown in FIG. 4 of the apparatus 100, fingers from the right hand of a user holding the apparatus 100 may therefore perform the translation motion. The skilled addressee will appreciate that this is of great advantage since it enables the user to use its right hand for both controlling applications running by either switching to a given one of them using a finger or terminating one using the method disclosed herein as well as also for holding the apparatus 100. This is of great advantage over the prior art.

It will be appreciated that the translation motion may be detected according to various methods known to the skilled addressee. Also various parameters may be used such as a length for the motion, etc.

According to processing step 306, the icon is moved. It will be appreciated that in a preferred embodiment, the icon is moved concurrently with the translation motion of the finger such that the icon appears to be “moved by the finger of the user”. It will be appreciated that in one embodiment the icon can be dragged out of the screen to be removed.

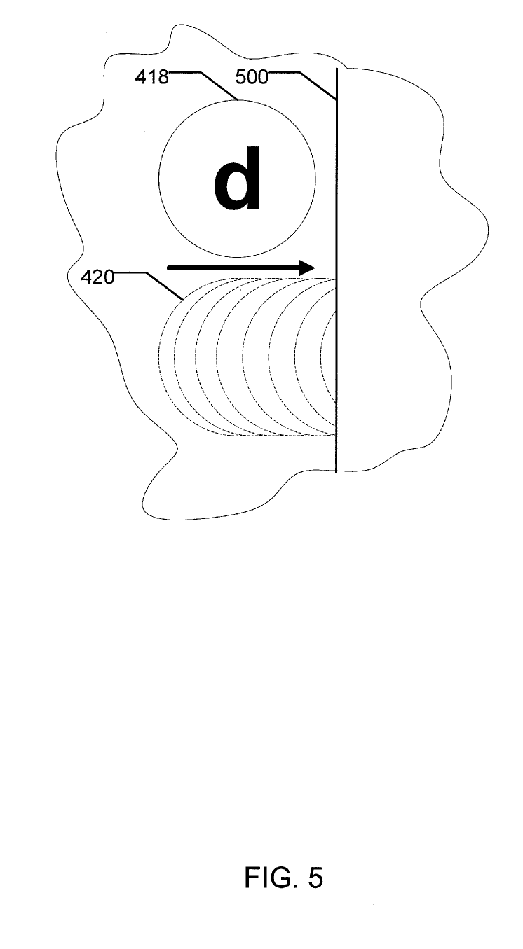

Now referring to FIG. 5, there is shown an embodiment of the user interface shown in FIG. 4, in which the icon 420 corresponding to application E is being moved.

According to processing step 308 a process is executed.

In a preferred embodiment, the process executed is one for terminating a given application running in the computing device 100.

In fact, it will be appreciated by the skilled addressee that the process may alternatively be of various types. For instance, the process may be one for transferring a file or application to a given location such as another processing unit. Alternatively, the process may be a scan to a web server. In another embodiment, it can be for performing an audio file conversion. In yet another embodiment, it can be for performing a file transfer. In another embodiment it can be to put an app (e.g. a calculator app) in an idle mode waiting for a user to reactivate it.

In fact, it will be appreciated that the embodiment disclosed herein may be used for giving a visual feedback about a running process.

It will be appreciated that the method disclosed herein may be implemented according to various embodiments and using various programming languages known to the skilled addressee.

Also, it will be appreciated that a computer-readable storage medium may be provided for storing computer-executable instructions. Such computer-executable instructions would cause, when executed, a computing device comprising a touch screen panel to perform a method for interacting with an application comprising displaying an icon on the touch screen panel, the icon being representative of the application and executing a given process upon detection of a finger motion, the finger motion starting above the icon and being in a direction facing the outside of the touch screen panel.

Although the above description relates to a specific preferred embodiment as presently contemplated by the inventor, it will be understood that the invention in its broad aspect includes mechanical and functional equivalents of the elements described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A method for interacting with an application in a computing device comprising a touch screen panel, the method comprising:
displaying an icon on the touch screen panel, the icon being representative of the application; and
executing a given process upon detection of a finger motion, said finger motion starting above the icon and being in a direction facing the outside of the touch screen panel.

2. The method as claimed in claim 1, wherein the application is currently running.

3. The method as claimed in claim 1, wherein the detection of a finger motion comprises detecting a selection of the icon and detecting a translation motion of a finger.

4. The method as claimed in claim 3, wherein the detection of the icon comprises detecting the touching of the icon by the finger.

5. The method as claimed in claim 4, wherein the detection of a translation motion of a finger is performed immediately following the touching of the icon by the finger.

6. The method as claimed in claim 5, wherein the icon is moved.

7. The method as claimed in claim 6, wherein the icon is moved concurrently with the translation motion of the finger.

8. The method as claimed in claim 5, wherein the translation motion of the finger is horizontal.

9. The method as claimed in claim 1, wherein the given process causes the application to be terminated when executed.

10. The method as claimed in claim 1, wherein the given process causes the application to be put in an idle mode when executed.

11. A computer-readable storage medium storing computer-executable instructions which, when executed, causes a computing device comprising a touch screen panel to perform a method for interacting with an application comprising:
displaying an icon on the touch screen panel, the icon being representative of the application; and
executing a given process upon detection of a finger motion, said finger motion starting above the icon and being in a direction facing the outside of the touch screen panel.

12. The computer-readable storage medium storing computer-executable instructions as claimed in claim 11, wherein the detection of a finger motion comprises detecting a selection of the icon and detecting a translation motion of a finger.

13. A computing device, comprising:
a touch screen panel;
one or more central processing units;
a memory comprising an application; and
one or more programs, wherein the one or more programs are stored in the memory and configured to be executed by the one or more central processing units, the one or more programs including:
instructions for displaying an icon on the touch screen panel, the icon being representative of the application; and
instructions for executing a given process upon detection of a finger motion, said finger motion starting above the icon and being in a direction facing the outside of the touch screen panel.

14. The computing device as claimed in claim 13, wherein the application is currently running.

15. The computing device as claimed in claim 14, wherein the given process causes the application to be terminated when executed.

16. The computing device as claimed in claim 14, wherein the given process causes the application to be put in an idle mode when executed.

17. The computing device as claimed in claim 15, wherein the detection of a finger motion comprises detecting a selection of the icon and detecting a translation motion of a finger.

18. The computing device as claimed in claim 16, wherein the detection of a finger motion comprises detecting a selection of the icon and detecting a translation motion of a finger.
